(19) United States
(12) Patent Application Publication
(10) Pub. No.: US 2010/0057353 A1
(43) Pub. Date: Mar. 4, 2010

(54) GPS Map for Commercial Vehicle Industry

(76) Inventor: Edward Friedman, Boston, MA (US)

Correspondence Address: Edward Friedman;TeleType Co., Inc, 10th floor, 44 School Street, Boston, MA, 02108, US

(21) Appl. No.: 12/199,815

(22) Filed: Aug. 28, 2008

(51) Int. Cl. G01C 21/34

(52) U.S. Cl. 701/209; 342/357.13

(57) ABSTRACT

GPS map for commercial vehicle industry comprising of a navigation system and user interface to optimize needed navigation for a commercial vehicle based on physical criteria and content taking into consideration low bridge clearances, load limits, one-way road designations, left-hand and dangerous turn restrictions, and allowances pertaining to commercial vehicles. Based on the specified dimension and content of the vehicle, the system will display roads on the map with alerting color, texture to warn driver about roads where location of the vehicle is prohibited.

### FIELD OF THE INVENTION

The present invention relates to the field of vehicle routing systems. More particularly the invention relates to a GPS map navigation and routing device for the commercial vehicle industry that allows dynamic change of road display on a moving map device and gives route guidance and prepares road route data in a map database based on the physical criteria and content of the vehicle.

### BACKGROUND OF THE INVENTION

The global positioning system comprises twenty four navigational satellites in high orbit about 20,000 km about the earth. The satellites transmit precise time and position information continuously and the transmissions can be received anywhere in the world by a suitable GPS receiver. By processing the information the transmission of the GPS receiver can determine its exact position fix via ranging. Each satellite transmits almanac and ephemeris data components. The almanac data components contain information on the location and operational status of satellites in the system. The ephemeris data components comprise the precise satellite positioning information that is used for ranging. At present the global positioning system is used for navigation between locations identified by an address given by their longitude and latitude. In other words the GPS system conventionally operates using address positioning whereby, in effect, to navigate from a first point to a second point the absolute addresses of each point must be specified. Whilst address oriented positioning is often suitable for machine to machine communications it is less preferable in person to person or machine to person communication as it requires the person involved to know his or her absolute position.

Vehicle information systems have been developed that provide various types of information to operators of those vehicles. These system uses the on-board map to plan a route from a starting point to a destination, which is specified by the operator of the vehicle. In some systems the operator inputs the desired destination (and the current location, if required by the system) by entering a spelling of the destination. Once the operator inputs the destination, the system plans a route along the road network to the destination. Once the route is planned, the operator is guided by the system along the route. In GPS, multiple satellites emit signals that allow an in-vehicle GPS receiver to estimate its absolute location.

The relevant prior art methods, which will deal with vehicle information systems, are as follows:

U.S. Pat. No. 5,917,435 discloses a navigation apparatus for vehicles which comprises a GPS receiver connected to a GPS antenna, a gyro sensor, a vehicle signal processing circuit for processing vehicle signals such as a vehicle speed signal, a CD unit for driving a CD-ROM containing map information, a display unit for displaying a map, and an ECU for controlling the entire operation, wherein at least the CD unit, the display unit and the ECU are disposed within a detachable unit which can be detachably installed in a vehicle.

U.S. Pat. No. 5,802,492 claims a Computer Aided Routing and Positioning System (CARPS) that determines a route along selected waypoints that include a travel origin and a travel destination and intermediate waypoints therebetween. The selected waypoints may be uploaded to or downloaded from various geocoding devices that utilize the Global Positioning System (GPS).

U.S. Pat. No. 6,418,375 describes a method of routing using an offboard navigation system for motor vehicles, in which road points, at which there is a road junction, and also the road distance between adjacent road points on a calculated route are stored in a memory element in the vehicle. Preferably, only those road points which are also turnoff points are stored. The distance from the next turnoff point at which a turnoff maneuver is to be effected is determined by comparing the distance covered since the last turnoff point with a stored value for the road distance between the adjacent turnoff points.

U.S. Pat. No. 6,321,158 details an Integrated Routing/Mapping Information System (IRMIS) that links desktop personal computer cartographic applications to one or more handheld organizer, personal digital assistant (PDA) or “palmtop” devices.

U.S. Pat. No. 6,268,825 claims a navigation control ECU that gives normal guidance to the driver of a vehicle based on the present location of the vehicle as determined from a D-GPS and map data from a map database. A map database detailing device obtains detailed data on the shape of a road from the detected valued of a yaw rate sensor, an acceleration sensor, and a vehicle speed sensor and the data of the map database, and stores the detailed data in a detailed map database. A vehicle control ECU evaluates the traveling stability of the vehicle at a curve and controls the deceleration, etc., of the vehicle by utilizing the detailed road shape data in the database.

U.S. Pat. No. 6,628,233 describes a vehicle information system which includes an in-vehicle system and a centralized server system. The in-vehicle system communicates with the server system using a wireless communication link, such as over a cellular telephone system. A position system, such as a set of GPS satellites, provides positioning signals that are used by the in-vehicle systems, and optionally by the centralized server system to increase the accuracy of position estimates. In one version of the system, an operator specifies a destination to an in-vehicle system which validates the destination. The in-vehicle system transmits specification of the destination to a server system at the centralized server. The server system computes a route to the destination and transmits the computed route to the in-vehicle system. The in-vehicle system guides the operator along the route. If the in-vehicle system detects that the vehicle has deviated from the planned route, it replans a new route to the destination using an in-vehicle map database.

U.S. Pat. No. 6,762,696 discloses a routing display for a navigation system in a road vehicle in the form of an electro-optical display can be driven by a routing computer and uses symbols to display a direction of current travel and a direction which is to be taken after a turn-off point relative to one another. The sizes of the two symbols relative to one another is changed such that the relative size of the symbol marking the direction which is to be taken after the turn-off point increases as the turn-off point is approached. Accordingly, when the driver looks at the routing display, he is given the visual impression that he is approaching the turn-off point.

U.S. Pat. 7,272,497 describes a vehicle navigation system (e.g., GPS) with multi-use display generator that provides for the switching of a displayed image from a navigational based image to a non-navigational image such as a favorite photo. This versatility allows for the user of a vehicle navigation to avoid having to look at a boring display of map images and instead view more desirable non-navigation images such as full 100% displays of a favorite photo shot.

U.S. Pat. 7,231,297 claims a navigation system which guides a subject vehicle to a destination by displaying at a display monitor an arrow indicating the direction of the next turn instead of displaying a map includes a decision-making device that makes a decision as to whether or not the subject vehicle is currently located on a recommended route to a destination set in advance based upon the current position of the subject vehicle, an abridged map generating device that generates an abridged map by abridging a map based upon map data and a display control device that displays at the display monitor the abridged map and the subject vehicle position if the decision-making device determines that the subject vehicle is not currently located on the recommended route.

However the route is typically planned by the above vehicle information systems to provide a shortest distance or to try to provide the shortest travel time and not based on the best route as per the physical criteria and content of a vehicle. Local and Federal authorities require certain type of vehicles with specific dimensions and content not to travel via certain streets. Presently the only way for a vehicle operator to know if he is located on a street where he permitted or not permitted to be is by reading the signs along the road at which point it might already be too late. Also some of the signs are not visible at night or in inclement weather such as snow or fog. Electronic devices that presently display moving maps inside vehicles display roads only according to their attributes such as the width of the lane or category of the street such as “Local Street” or “State Road” or “Interstate Freeway”. These roads may or may not be suitable for commercial traffic.

Again the above vehicle information systems do not have a portable carry on GPS map device.

Further the above vehicle information systems do not have color of roads changing with parameters specified.

Further the present invention differs from the existent prior art in that it provides one route that precisely fits the need of the truck driver based on the characteristics of the vehicle including size, weight, height, and hazmat considerations, rather than a series of possible routes.

It will be apparent to those skilled in the art that the objects of this invention have been achieved by providing a GPS map navigation device for the commercial vehicle industry which is unique in nature unlike existing models that are suited only for limited purposes. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This invention may be summarized, at least in part, with reference to its objects.

The foremost object of this invention is to exclusively present a GPS map navigation device to optimize needed navigation for a commercial vehicle based on physical criteria and content.

Another object of the present invention is to give a GPS map navigation device that plans the route taking into consideration, size, weight, hauling contents, among other considerations.

Yet another object of the present invention is to give a GPS map navigation device that allows dynamic change of road display on moving map device for special use vehicles.

A further object of the present invention is to provide a GPS map navigation device where each route will be designated by color or texture to indicate to the driver if the road is suitable for travel.

Additional objects, advantages and novel features of the invention will be set forth in part in the description which follows, and in part will become apparent to those skilled in the art upon examination of the following, or may be learned by practice of the invention.

These and other objects and advantages and features of the present invention will be more readily apparent when considered in reference to the following description and when taken in conjunction with the accompanying drawings listed below.

Images 1 through 11 show dynamic change in road or routes based on the type of vehicle in use or inclination of the road.

Image 1 is a diagram illustrating the setting for car navigation.

Image 2 is a diagram illustrating the display of all streets and roads available for navigation.

Image 3 is a diagram illustrating the setting for Truck Routing with restriction of 12 feet, 52 feet 10 inches and less then 4000 pounds.

Image 4 is a diagram illustrating the display of showing restriction where such parameters apply.

Image 5 is a diagram illustrating the setting for truck routing with restriction of 13 feet 6 inches, 53 feet long and less then 80000 pounds

Image 6 is a diagram illustrating the map display of showing restriction where such parameters apply.

Image 7 is a diagram illustrating the information on restrictions for the particular section of the road on the Information menu.

Image 8 is a diagram illustrating the information of the restrictions of the road with weight limitation on the Information menu.

Image 9 is a diagram illustrating the information of the restriction of the road with restrictions for Hazardous Materials

Image 10 is a diagram illustrating the display of a route with visible restricted roads.

Image 11 is a diagram illustrating the display on Navigational Panel of upcoming slope.

### DETAILED DESCRIPTION OF THE INVENTION

The following description is presented to enable any person skilled in the art to make and use the invention, and is provided in the context of particular applications of the invention and their requirements. The present invention can be configured as follows:

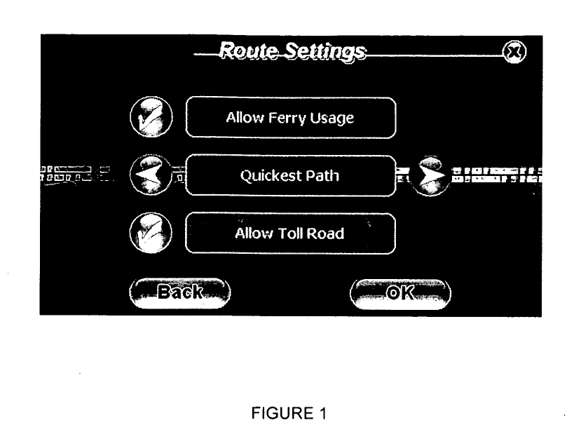

According to FIG. 1, the settings for a GPS map for commercial vehicles is shown, which includes a vehicle and a computer that is onboard the vehicle. The present invention includes an onboard computer, including storage for a map database, a wireless communication system for passing data between the onboard computer and a remote server, an input/output device for providing a user interface between the onboard computer and an operator of the vehicle, and a vehicle sensor for providing motion-related signals to the onboard computer. The onboard computer is programmed to perform the functions of accepting a planned route from the server over the wireless communication system, maintaining a first location estimate of the vehicle using the motion-related signals from the vehicle sensor, and, using the planned route and the first location estimate, providing guidance instructions to the operator through the input/output device. As mentioned the invention is electrically connected as shown to a satellite-implemented global positioning system (GPS) transceiver that is in communication with the computer. Accordingly, the computer can receive information from the transceiver that represents the location of the vehicle on the earth's surface.

Additionally, the computer is associated with one or more peripheral devices, including a data entry device such as a keypad. Further, a graphical display screen is associated with the computer for displaying the preferred route between an operator-selected origin “A” and an operator-selected destination “B”, based on the vehicle's physical parameters.

The keypad, graphical display can be conveniently mounted on the dashboard or on some other suitable surface of the vehicle. In one preferred embodiment, the displays are flat touch screen panel displays such as light emitting diode (LED) displays or liquid crystal displays (LCD).

Thus the invention also contains the following additional components as part of or attached to it:

1. External Antenna

2. Voice directions—Pronounces street names in English or Spanish

3. MP3 & Video Player—for relaxation during loading or rest time

4. Bluetooth—Hands Free Port for Cell Phone Use

5. Automatic reverse camera detection

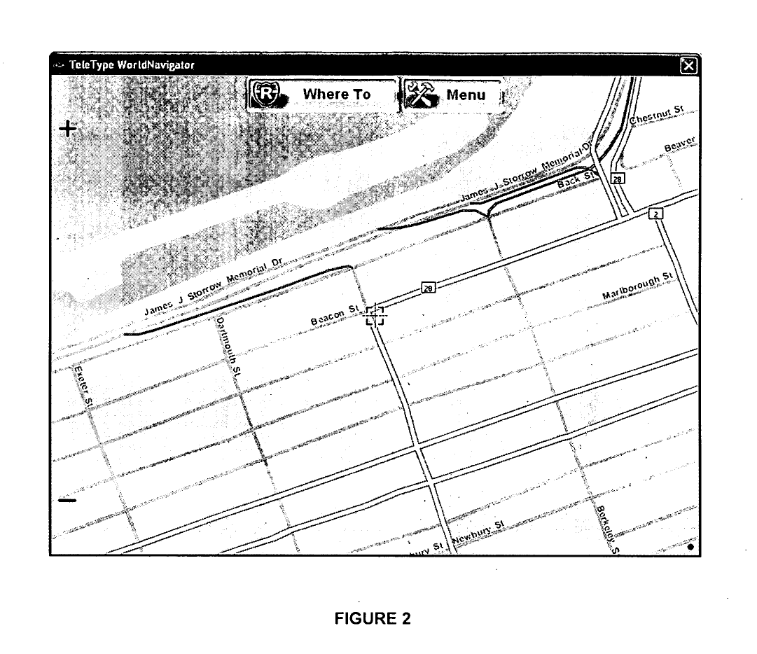

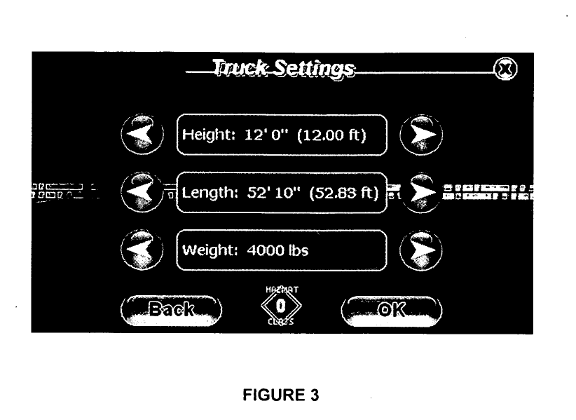

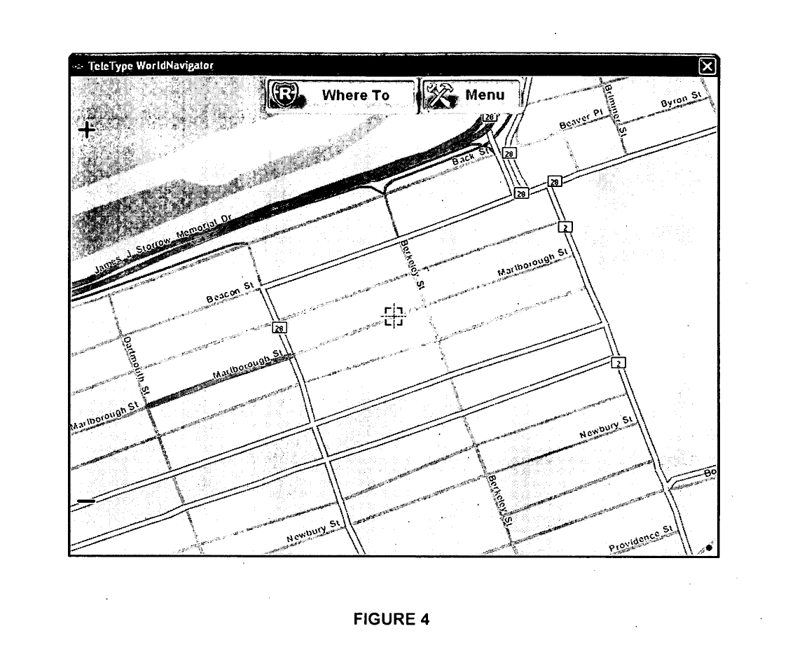

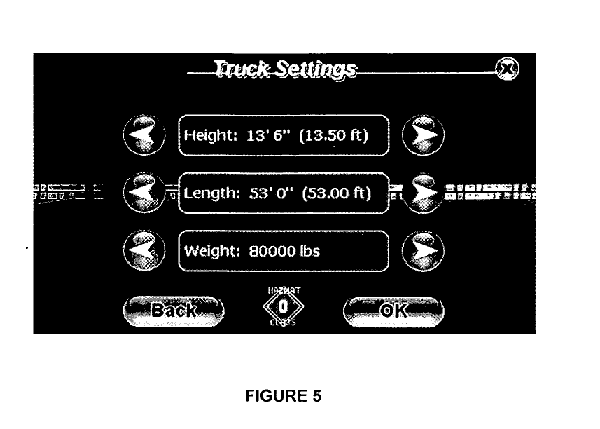

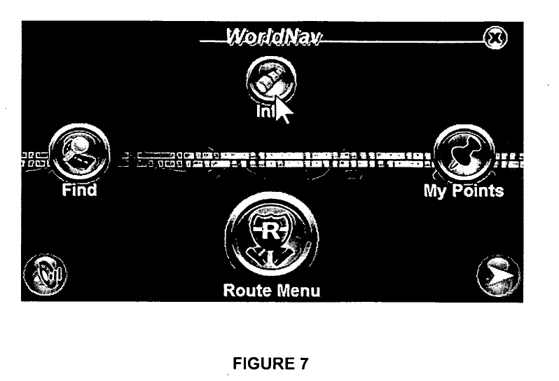

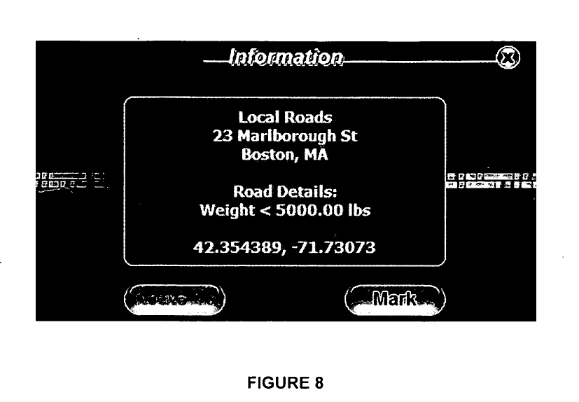

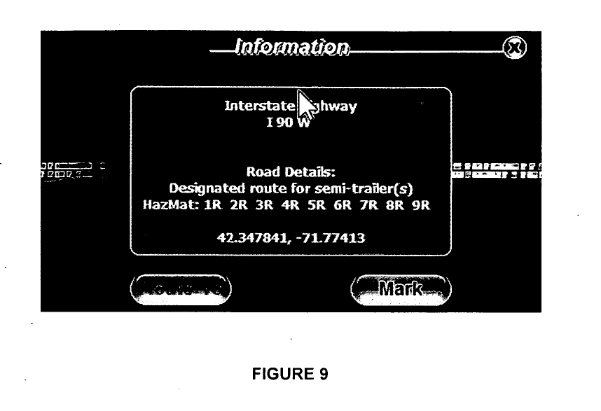

The structures of the modules of the present invention may be embodied in computer program software or in logic circuits. Those skilled in the art will appreciate that FIGS. 1-11 illustrate the structures of computer program code elements that function according to this invention. Manifestly, the invention is practiced in its essential embodiment by a machine component that renders the computer program code elements in a form that instructs a digital processing apparatus (that is, a computer) to perform a sequence of function steps corresponding to those shown in the Figures.

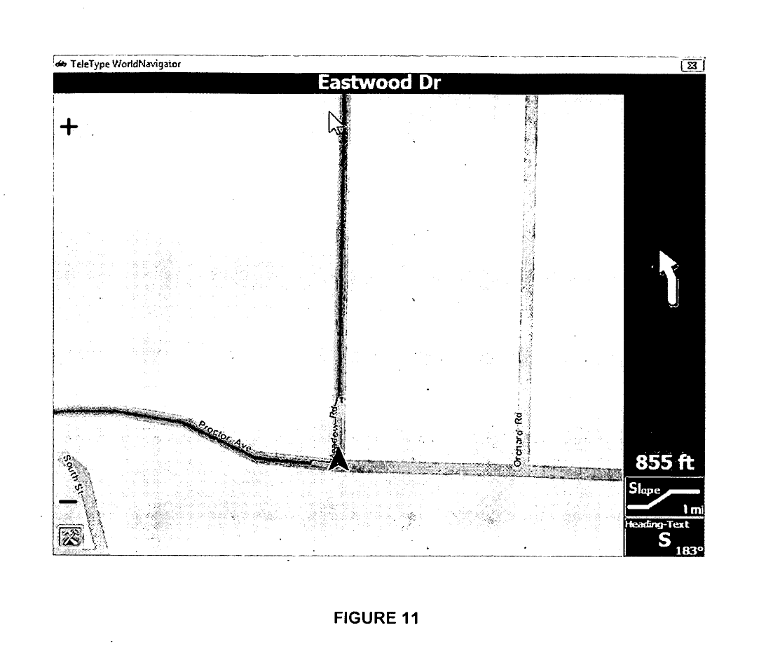

When embodied in software, these instructions may reside on a program storage device including a data storage medium, such as can be found on a computer floppy diskette, on semiconductor devices, on magnetic tape, on optical disks, on a DASD array, on magnetic tape, on a conventional hard disk drive, on electronic read-only memory or on electronic random access memory, or other appropriate data storage device. In an illustrative embodiment of the invention, the computer-executable instructions may be lines of compiled C.sup.++ language code. In any case, apart from the particular computer program storage device (i.e., firmware logic circuits or software) that embodies the modules to establish a program means which embodies logic means that are recognizable by the computer to perform the method steps disclosed below.
1. The user enters the vehicle origin and destination addresses along with criterions of the vehicle dimension and content on the invention to determine the best route. Thus vehicle routing criterions depends on the vehicle parameters. Criterion of the route is limited to at least one of maximums like maximum vehicle height, maximum vehicle width, and maximum vehicle length or maximum number of Category of Hazardous Materials allowed.
2. The invention then determines the best route insuring avoidance of restricted areas and can interactively present information to the driver so as to make some of his decisions more informative in route preparation.
3. Based on the specified dimension and content of the vehicle, the invention will display roads on the map with alerting color, texture to warn driver about roads where location of the vehicle is prohibited.
4. Best Routing and Rerouting is based on vehicle criteria including fuel consumption that in turn depend on speed of travel, idling time and elevations vehicle will have to overcome
5. Based on the specified dimension and content of the vehicle, the invention will display roads on the map with alerting color, texture to warn driver about roads where location of the vehicle is prohibited.
6. The navigation device of the invention will provide interactive display of upcoming elevation so that driver can optimize the speed and gearing before uphill or downhill travel as illustrated in FIG. 11. This helps the vehicle operator to set up speed and gears correctly and optimize fuel consumption of the vehicle.
7. Search for a particular address will check if the destination locates on a section of the road that can be approach by a vehicle with specific parameters and content

In general, in one aspect, the invention is a vehicle information system. The vehicle information system features an in-vehicle system and a centralized server system. The in-vehicle system communicates with the server system using a wireless communication link.

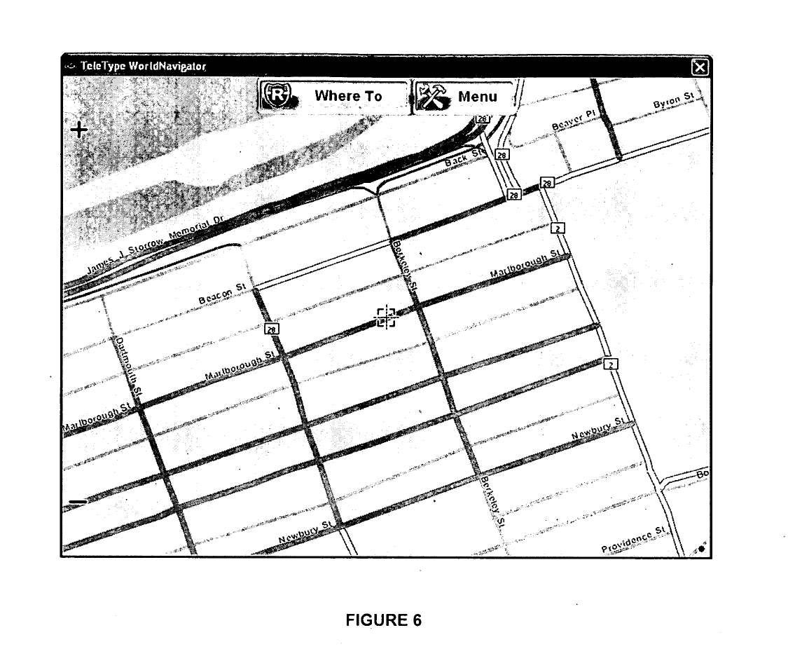

In general, in another aspect, the invention is a method for guiding a vehicle through a road network from a starting location to a destination, based on the vehicle parameters. The method features transmitting a specification of the destination to a server, for example by transmitting a street address or an identifier of a point of interest and the vehicle parameters. The server determines a route to the specified destination and transmits a specification of the route to the vehicle. Roads that prohibit the vehicle designated in Pink Color. The method features receiving at the vehicle a planned route to a destination location from a server, and storing the planned route at the vehicle. The method also includes receiving from the server a specification of a planned route through the road network to the destination as well as receiving from the server a map that includes a specification of the road network in the vicinity of the planned route as depicted in FIG. 6 to 10.

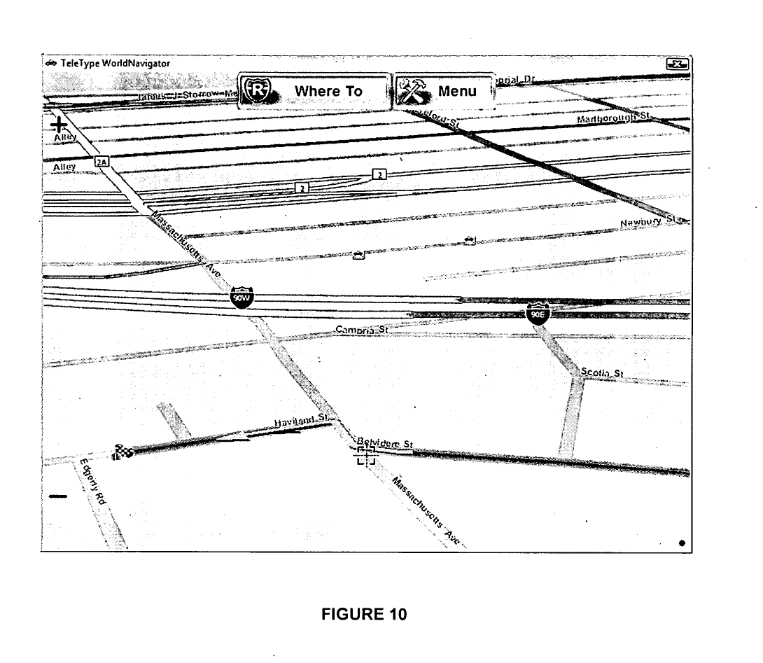

For instance, the map can correspond to one or more regions around particular points on the planned route, correspond to a “corridor” around the planned route, or be a complex shaped region in the vicinity of the route. The planned route can include specifications of a multiple maneuvers to be carried out by the vehicle, and the specification of each maneuver then includes a location of the maneuver. The map can be in the vicinity of the starting location, or in the vicinity of one of the specified maneuvers. The method can also feature tracking the location of the vehicle as featrued in FIG. 10. The method can also feature displaying the received map in conjunction with a representation of the planned route, and a location of the vehicle. The displayed map can provide useful information to an operator of a vehicle during difficult maneuvers where turn-by-turn instructions.

The method features receiving a reference signal from a positioning system, for example receiving signals from GPS satellites, and computing position data related to the location of the vehicle using the received reference signal. For example, the position data can be latitude and longitude estimates, or can be GPS pseudorange measurements. The method also features transmitting the position data to a server and receiving from the server position correction data. For example, the position correction can be a deviation in latitude and longitude, or can be correction terms to be applied to GPS pseudorange measurements. The method also features determining estimated coordinates of the vehicle including combining data computed from the received reference signal and the position correction data.

The method of the invention can feature repeatedly computing the position data, and determining the estimated coordinates, including combining the position data and the position correction data. The method can also feature, subsequent to the interval of time, repeatedly computing the position data and determining estimated coordinates of the vehicle using the position data without using the correction data.

The method can also feature planning an initial route. The initial route includes an initial set of multiple intermediate points coupled by road segments. The planned route is formed from the initial route. For any of the road segments in the initial route for which the difference in locations of the intermediate points bounding that segment is greater than can be specified in the allocated number of bits, the method includes inserting additional intermediate points on that road segment so that the differences between the locations of the adjacent intermediate points can each be specified in the allocated number of bits.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A portable GPS map device and method of displaying and searching road network and vehicle routing comprising of a navigation system and user interface to optimize needed navigation for a commercial vehicle wherein such optimization is based on physical criteria and content of the said vehicle, and external road criteria such as low bridge clearances, load limits, one-way road designations, left-hand and dangerous turn restrictions, and allowances pertaining to commercial vehicles.

2. Portable GPS map device as claimed in claim 1, wherein said map device includes an onboard computer, storage for a map database, a wireless communication system for passing data between the onboard computer and a remote server, an input/output device for providing a user interface between the onboard computer and an operator of the vehicle, a vehicle sensor for providing motion-related signals to said onboard computer and computer program software or logic circuits.

3. Portable GPS map device as claimed in claim 1 and 2, wherein said map device further comprises a receiver for receiving location information from a satellite, the receiver being in communication with said computer for sending location information thereto.

4. Portable GPS map device as claimed in claim 1 and 2, wherein said map device further comprises a vehicle holding said receiver, the location information being representative of the location of said vehicle on the earth.

5. A method as claimed in claim 1, wherein user enters the vehicle origin and destination addresses on said invention.

6. A method as claimed in claim 1, wherein user enters criterions of vehicle dimension and content including maximum vehicle height, maximum vehicle width, and maximum vehicle length or maximum number of Category of Hazardous Materials allowed.

7. A method as claimed in claim 1, wherein said invention interactively presents information to the driver by providing a stored map of a road network, receiving at the vehicle from a server a planned route to a destination location; storing the planned route at the vehicle; providing instructions to user according to the stored planned route; tracking a location of the vehicle, including detecting whether the vehicle has deviated from the planned route; and if the vehicle is detected to have deviated from the planned route, planning a new route to the destination location using the stored map.

8. A method as claimed in claim 1, wherein said computer is in communication with the database, said computer receiving the origin and destination, and accessing said database to determine possible routes existing between the origin and the destination, and determining a select route among the possible routes.

9. A method as claimed in claim 1, wherein said invention displays interactive road map on said LCD screen with different colors and texture.

10. A method as claimed in claim 1, wherein said invention displays interactive road map on said LCD screen featuring Best Routing and Rerouting based on said vehicle criteria including fuel consumption.

11. A method as claimed in claim 1, wherein said invention displays interactive road map on said LCD screen featuring upcoming elevation.

12. A method as claimed in claim 1, wherein said invention displays interactive road map on said LCD screen featuring usability of road to a particular address, based on said vehicle criteria.

13. A method as claimed in claim 1, wherein said software is recorded on a computer readable medium for causing an in-vehicle computer to perform the said functions.
